(19) United States
(12) Patent Application Publication
(10) Pub. No.: US 2015/0067148 A1
(43) Pub. Date: Mar. 5, 2015

(54) AUTOMOTIVE OPEN SYSTEM ARCHITECTURE (AUTOSAR)-BASED COMMUNICATION METHOD AND COMMUNICATION APPARATUS THEREOF

(71) Applicant: ELECTRONICS AND TELECOMMUNICATIONS RESEARCH INSTITUTE, Daejeon (KR)

(72) Inventor: Jong-Uk KIM, Daejeon (KR)

(73) Assignee: ELECTRONICS AND TELECOMMUNICATIONS RESEARCH INSTITUTE, Daejeon (KR)

(21) Appl. No.: 14/291,137

(22) Filed: May 30, 2014

(30) Foreign Application Priority Data
Aug. 27, 2013 (KR) 10-2013-0101978

(51) Int. Cl. H04L 12/26; H04L 29/08

(52) U.S. Cl. CPC H04L 43/08; H04L 67/12
USPC 709/224

(57) ABSTRACT

An Automotive Open System Architecture (AUTOSAR)-based communication method and communication apparatus. According to an exemplary embodiment, the AUTOSAR-based communication method may filter input data, using a data range filter, a first valid data filter, or a second valid data filter, in order to decrease the length of an interrupt operation, and improve processing speed of an overall application system.

### CROSS-REFERENCE TO RELATED APPLICATION(S)

This application claims the benefit under 35 U.S.C. §119(a) of Korean Patent Application No. 10-2013-0101978, filed on Aug. 27, 2013, in the Korean Intellectual Property Office, the entire disclosure of which is incorporated herein by reference for all purposes.

### BACKGROUND

1. Field

The following description relates to a technology on the basis of a network, more specifically an Automotive Open System Architecture (AUTOSAR)-based communication technology.

2. Description of the Related Art

Currently, an Electronic Control Unit (ECU) has been increasing, that is, a vehicle to which an Automotive Open System Architecture (AUTOSAR) standard is applied. Each ECU is configured in an environment named a communication bus, where the ECU can communicate with each other. As the number of ECU increases, a size or number of data to be communicated with each other also increases. As for firmware, due to the high degree of freedom despite a large number of communication messages, a developer can flexibly deal with interrupt processing of messages. However, in an AUTOSAR platform, limitations increase due to standardized rules. So, as the number of messages increases, interrupt operations increase, causing the general processing speed of an application system to slow down. In such a case, the burden of design may fall on a network message designer or an application system developer. In actuality, because of the increases in communication messages, redesigning and redeveloping often occur even after application development has been completed.

### SUMMARY

The following description relates to an Automotive Open System Architecture (AUTOSAR)-based communication method and communication apparatus to decrease a length of an interrupt operation through an expansion of a filtering function of an AUTOSAR Controller Area Network (CAN) interface, in order to improve processing speed of an overall application system, and additionally help an application developer and a CAN developer.

In one general aspect, an Automotive Open System Architecture (AUTOSAR)-based communication method includes setting a filtering condition based on a data range; and determining whether input data fulfills the filtering condition, and filtering the input data.

In another general aspect, an Automotive Open System Architecture (AUTOSAR)-based communication method includes setting a filtering condition based on an absolute value or a relative value of valid data; and determining whether input data fulfills the filtering condition, and filtering the input data.

In another general aspect, an Automotive Open System Architecture (AUTOSAR)-based communication apparatus includes at least one of a data range filter to set a filtering condition based on a data range, determine whether input data exists within the data range that is preset, and filter the input data based on the determination result; a first valid data filter to set a filtering condition based on an absolute value of valid data, compare the input data and the absolute value that is preset, and filter the input data according to the comparison result; and a second valid data filter to set a filtering condition based a relative value of on the valid data, compare present input data and previous input data, and filter the input data according to the comparison result.

Other features and aspects may be apparent from the following detailed description, the drawings, and the claims.

### BRIEF DESCRIPTION OF THE DRAWINGS

FIG. 1 is a diagram illustrating an example of a flow of Controller Area Network (CAN) communications according to an exemplary embodiment of the present invention.

FIG. 2 is a diagram illustrating an example of CAN communications according to an exemplary embodiment of the present invention.

FIG. 3 is a diagram illustrating an example of a data filtering method using a data range filter according to an exemplary embodiment of the present invention.

FIG. 4 is a diagram illustrating an example of a data filtering method that uses a first valid data filter, which uses an absolute value according to an exemplary embodiment of the present invention.

FIG. 5 is a diagram illustrating an example of a data filtering method that uses a second valid data filter, which uses a relative value according to an exemplary embodiment of the present invention.

FIG. 6 is a diagram illustrating an example of a data filtering method using a data interval filter, a first valid data filter, and a second valid data filter, according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

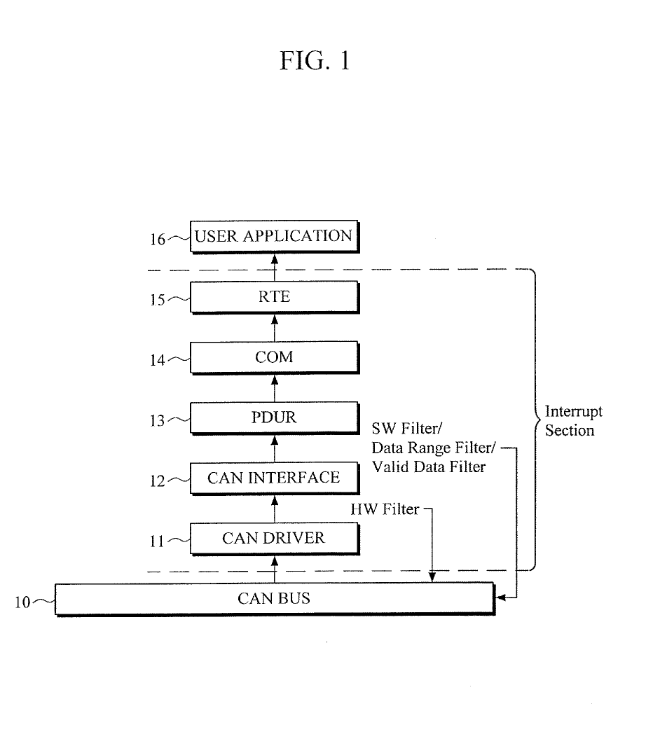

FIG. 1 is a diagram illustrating an example of a flow of Controller Area Network (CAN) communications according to an exemplary embodiment of the present invention.

Referring to FIG. 1, each Electronic Control Unit (ECU) in a vehicle transmits and receives a message to and from each other over a network, such as Controller Area Network (CAN). Specifically, the message that is input to a CAN driver 11 passing through a CAN bus 1 is transformed into a message, which is internally pre-set by a CAN interface (CAN IF) 12. Then, the message is transferred to a user application 16 passing through a Protocol Data Unit Router (PDUR) 13, a COM 14, and a Runtime Environment (RTE) 15. The CAN driver 11, the CAN IF 12, the PDUR 13, COM 14, and RTE 15 are included in an interrupt section that interrupts the message. The CAN driver 11 and the CAN IF 12 have a SW filter and a HW filter, respectively, and only the message passing through each filter is transferred to an upper module.

However, after the CAN IF 12 previously receives and transfers a message A with a value of 100 to the user application 16, if the CAN IF 12 currently receives another message that has the equivalent value of 100, and then transfers the message from the interrupt section to the RTE 15, many restrictions may occur. For example, the number of input messages increases thereby increasing interrupt operations, and a processing speed of an overall application system may decrease. Therefore, a network message designer or an application system developer may feel the burden of designing during a designing step. And in actuality, because of the large number of communication messages, redesigning and redeveloping often occurs even after the application development has been completed.

As illustrated in FIG. 1 according to an exemplary embodiment, to solve the problems previously mentioned, two filters are added to the CAN IF 12, such as a data range filter and a valid data filter so that the length of the interrupt operations is decreased, thus improving a processing speed of the overall application system.

The data range filter may set a filtering condition based on the data range, and determine whether the input data is included in the preset data range. According to the determination, the data range filter may filter the input data. The first valid data filter may set a filtering condition based on an absolute value of the valid data, and filter the input data according to a comparison result of the input data and the preset absolute value. Also, the second valid data filter may set a filtering condition based on a relative value of the valid data, and filter the input data according to the comparison result of present input data and previous input data.

In an embodiment, the CAN IF 12 may filter the input data using each of the data range filter, the first valid data filter, or the second valid data filter. In another embodiment, the CAN IF 12 may filter the input data using a combination of at least two filters among the data range filter, the first valid data filter, and the second valid data filter, which are mentioned above.

In an embodiment, the CAN IF 12 may execute an interrupt operation that transfers the input data to an upper module if the input data fulfills an OR condition that fulfills one of the filtering conditions fulfilled through usable filters. If not, the CAN IF 12 may not transfer the input data to the upper module, and stop the interrupt operation. In another embodiment, the CAN IF 12 may execute the interrupt operation that transfers the input data to the upper module if the input data fulfills an AND condition that fulfills all of the filtering conditions through the usable filters. If not, the CAN IF 12 does not transfer the input data to the upper module, and stops the interrupt operation.

In response to those operations, filtered messages increase, and the interrupt operations decrease in accordance with the increased filtered messages. That is, if the input data does not fulfill a predetermined filtering condition, the CAN IF 12 may not transfer the present input data to the upper module, and may directly stop the interrupt operation, thereby decreasing operation length, and benefitting an overall system.

The exemplary embodiments mainly describes in-vehicle communications using a CAN communication protocol; however, other communication protocols, such as Local Interconnect Network (LIN), FlexRay, and the like, may be applied to the in-vehicle communication, as well as the CAN.

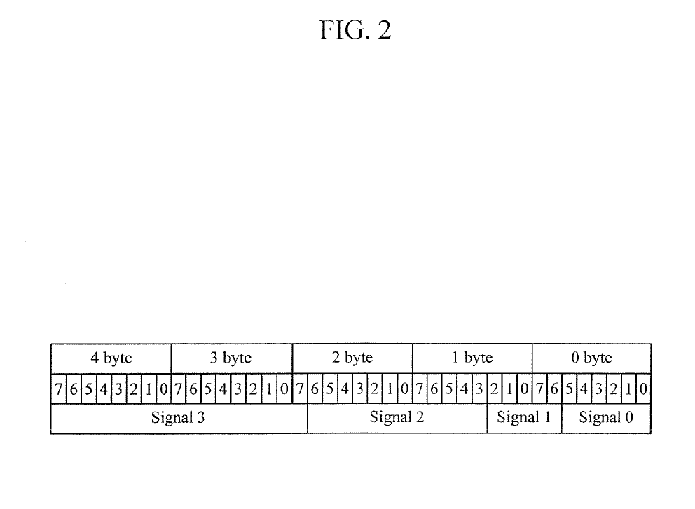

FIG. 2 is a diagram illustrating an example of CAN communications according to an exemplary embodiment of the present invention.

Referring to FIG. 2, there are two methods for processing a message for a CAN communication in AUTOSAR. That is, the message is processed in the AUTOSAR CAN communication in a minimum unit, which is a byte unit, or in a signal unit. The signal unit may be both bit-sized and byte-sized. In other words, a size of one signal may be one bit, or be processed in one signal by grouping a plurality of bytes.

In an embodiment, a data range filter and a valid data filter that are absent in an existing AUTOSAR are added. Here, the filters may execute filtering by a byte unit or a signal unit. The filters that can be used at each of two unit levels may be located in the CAN IF module in the AUTOSAR standard.

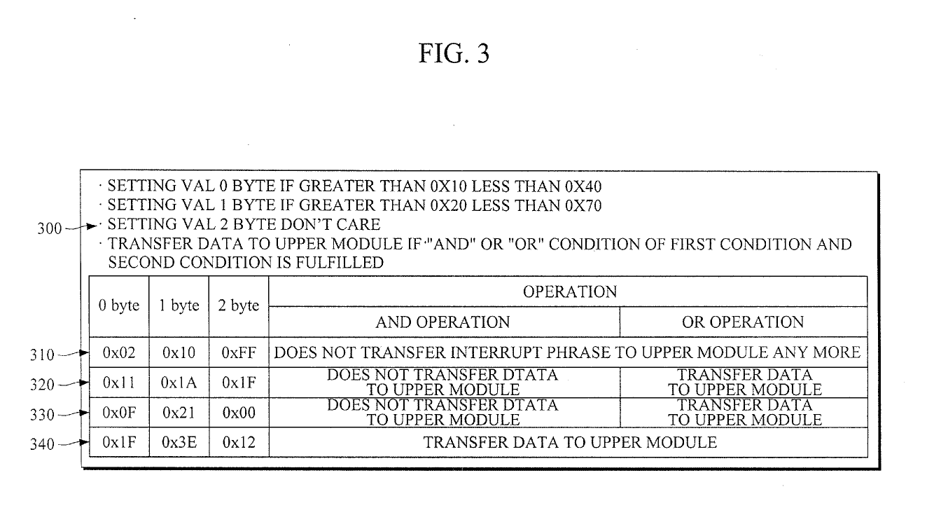

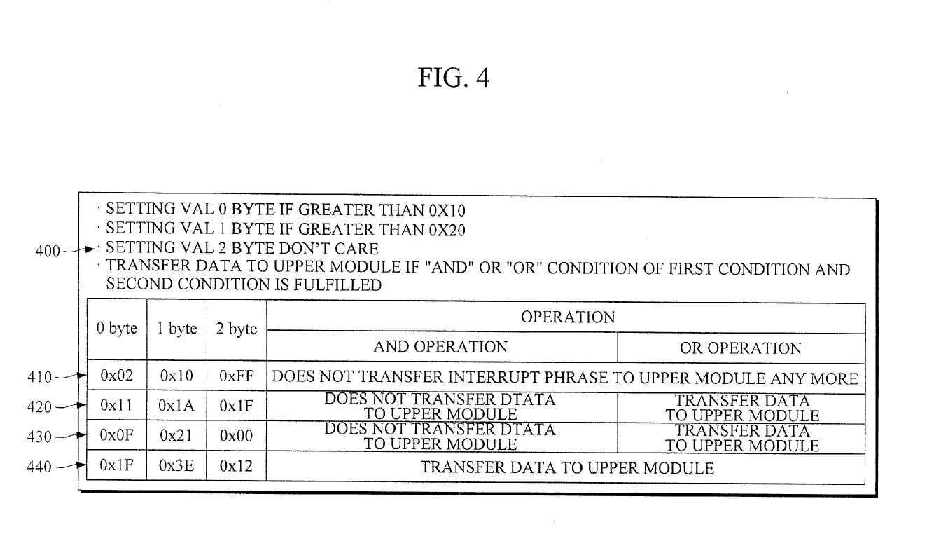

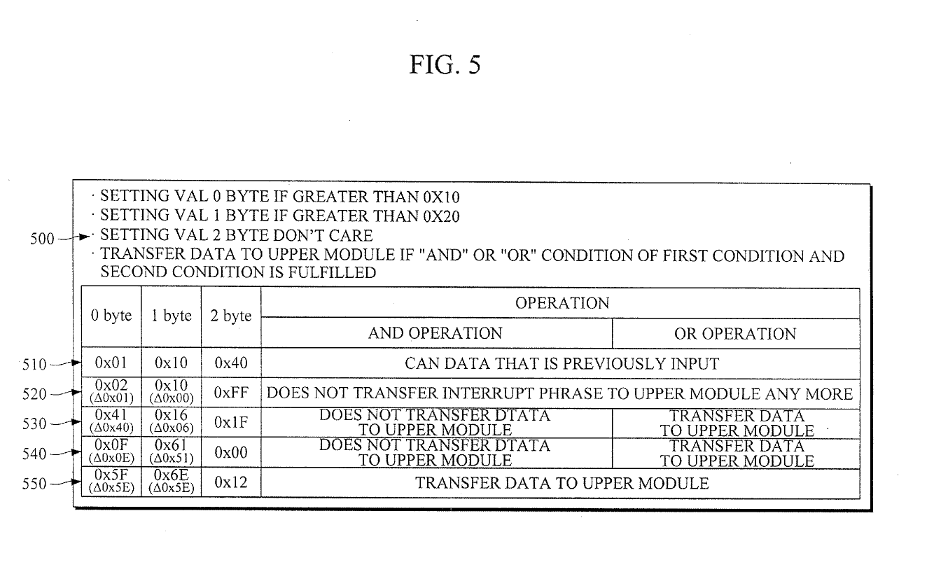

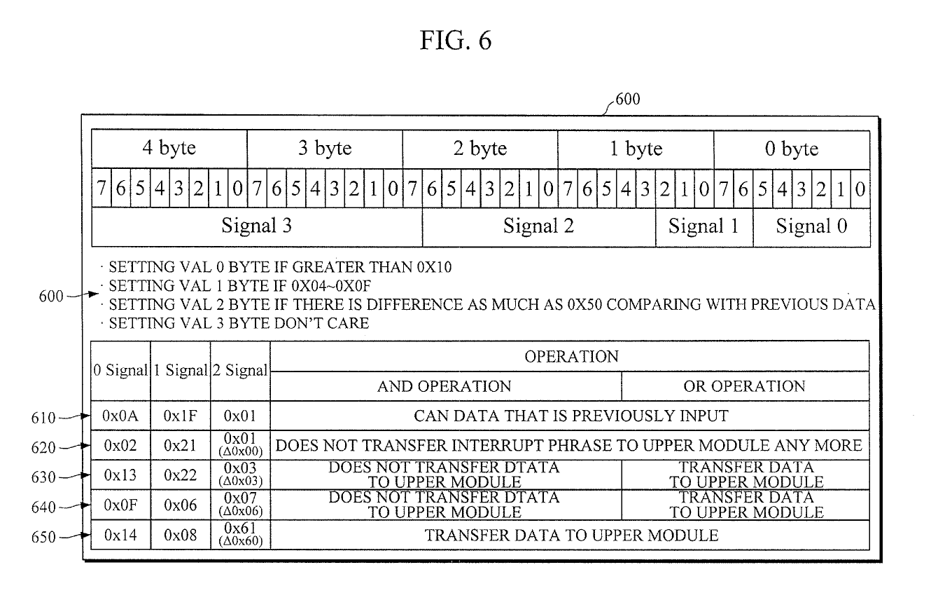

To classify filtering methods in a data unit of the input data that is filtered, FIGS. 3 to 5 illustrate methods for filtering the input data in a byte unit, and FIG. 6 illustrates a method for filtering the input data in a signal unit. Also, to classify the filtering method by a filter type, FIG. 3 illustrates a method that uses the data range filter; FIG. 4 illustrates a method that uses a first valid data filter, which uses an absolute value; FIG. 5 illustrates a method that uses a second valid data filter, which uses a relative value. In addition, FIG. 6 illustrates a method that uses all filters of the data range filter, the first valid data, and the second valid data filter for filtering the input data in the signal unit. Hereinafter, various filtering methods are described referring to figures described later.

FIG. 3 is a diagram illustrating an example of a data filtering method using a data range filter according to an exemplary embodiment of the present invention.

Referring to FIG. 3, a data range filter sets a filtering condition based on a preset data range, and filters the input data after determining whether the input data fulfills the filtering condition. At this time, the data range filter may filter the input data in a byte unit or a signal unit; however, FIG. 3 illustrates an example of a method for filtering the input data in a byte unit.

In an embodiment, if the input data is a value that exists within a preset data range, the data range filter executes an interrupt operation that transfers the input data to an upper module. If not, the data range filter does not transfer the input data to the upper module, and stops the interrupt operation.

In particular, if the input data includes a plurality of data units including a first data unit, a second data unit, and a third data unit, the filtering condition of the data range filter, a filtering condition of the data range filter is described as follows: A first condition transfers the input data to the upper module if the first data unit is a value that exists within the first data range. A second condition transfers the input data to the upper module if the second data unit is a value that exists within the second data range. Here, the data unit is a ‘byte’ or ‘signal’. The third data unit of the input data may not have the filtering condition.

In an exemplary embodiment, the data range filter may execute an interrupt operation that transfers the input data to the upper module if the input data fulfills an ‘or’ condition that fulfills one of the first and second conditions mentioned above. If not, the data range filter may not transfer the input data to the upper module, and stop the interrupt operation. In another exemplary embodiment, the data range filter may execute the interrupt operation that transfers the input data to the upper module if the input data fulfills an ‘and’ condition that fulfills all of the first and second conditions mentioned above. If not, the data range filter may not transfer the input data to the upper module, and stop the interrupt operation.

Hereinafter, to help with the understanding of a filtering method that uses the data range filter, a detailed exemplary embodiment is described later referring to FIG. 3. As illustrated in a reference numeral 300 of FIG. 3, 0-th byte and 1st byte are used in the data range filter. Here, AND operation or OR operation may be used. The AND operation indicates an operation transferring the input data to the upper module if all of the 0-th and 1st bytes fulfill a filtering condition. The OR operation indicates an operation transferring the input data to the upper module if at least one of the 0-th and 1st bytes fulfill a filtering condition.

In an exemplary embodiment as illustrated in the reference numeral 300 of FIG. 3, the filtering condition includes a first condition to transfer the input data to the upper module when the 0-th byte is greater than 0x10 and less than 0x40, and a second condition to transfer the input data to the upper module when the 1st byte is greater than 0x20 and less than 0x70. In addition, a 2nd byte does not use the filter.

According to an exemplary embodiment, in case 310 of the AND and OR operations, in which both the 0-th and 1st bytes do not fulfill the first and second conditions, the data range filter may stop the interrupt operation and not transfer the input data to the upper module any more. In another exemplary embodiment, in case 320 of the AND operation, in which the 0-th byte fulfills the filtering condition but the 1st byte does not fulfill the filtering condition, the data range filter may stop the interrupt operation, and may not transfer the input data to the upper module any further. However, in the OR operation, the data range filter may transfer the input data to the upper module. Also, in case 330 of the AND operation, in which the 0-th byte does not fulfill the filtering condition and the 1st byte fulfills the filtering condition, the data range filter may stop the interrupt operation, and may not transfer the input data to the upper module any further. However, in the OR operation, the data range filter may transfer the input data to the upper module. Meanwhile, in the case of 340 where all the 0-th and 1st bytes fulfill the filtering condition, the data range filter may transfer the input data to the upper module in the AND and OR operations.

FIG. 4 is a diagram illustrating an example of a data filtering method that uses a first valid data filter, which uses an absolute value according to an exemplary embodiment of the present invention.

Referring to FIG. 4, a first valid data filter sets a filtering condition based on an absolute value, determines whether the input data fulfills the filtering condition, and then filters the input data. At this time, the valid data filter may filter the input data in a byte unit or a signal unit; however, FIG. 4 illustrates the exemplary embodiment of filtering the input data in a byte unit.

In an exemplary embodiment, the filtering condition of the first valid data filter includes a condition that compares the input data and the preset absolute value, and transfers the input data to the upper module according to the comparison result. Particularly, in a case where the input data consists of a plurality of data units that include a first data unit, a second data unit, and a third data unit, the filtering condition includes a first condition and a second condition. Here, the first condition is for transferring the input data to the upper module according to the comparison result of the first data unit and the first absolute value. And the second condition is for transferring the input data to the upper module according to the comparison result of the second data unit and the second absolute value. Here, the data unit is a byte or a signal.

Hereinafter, to help with the understanding of a filtering method using the first valid data filter described above, a detailed exemplary embodiment may be described referring to FIG. 4. As shown by a reference numeral 400 in FIG. 4, a 0-th and 1st bytes are used in the first valid data filter, and a 2nd byte does not use the filter. Through AND operation, in a case where both the 0-th and 1st bytes fulfill the filtering condition, the first valid filter transfers the input data to the upper module. Through OR operation, in a case where at least one of the 0-th and 1st bytes fulfills the filtering condition, the first valid filter transfers the input data to the upper module.

In an exemplary embodiment as illustrated in the reference numeral 400 in FIG. 4, the filtering condition includes a first condition and a second condition. The first condition is transferring the input data to the upper module if the 0-th byte is greater than 0x10 is the first condition. Transferring the input data to the upper module if the 1st byte is greater than 0x20 is the second condition.

According to an exemplary embodiment, in case 410 of both the AND and OR operations, in which the 0-th and 1st bytes do not fulfill a first condition and a second condition, respectively, the first valid filter stops the interrupt operation in both the AND and OR operations, and does not transfer the input data to the upper module any further. Meanwhile, in case 420 of the AND operation, in which the 0-th byte fulfills the first condition but the 1st byte does not fulfill the second condition, the first valid filter stops the interrupt operation, and does not transfer the input data to the upper module any further. However, in the OR operation, the first valid filter transfers the input data to the upper module. According to another exemplary embodiment, in case 430 of the AND operation, in which the 1st byte fulfills the second condition but the 0-th byte does not fulfill the first condition, the first valid filter stops the interrupt operation, and does not transfer the input data to the upper module any more. Meanwhile, in the OR operation, the first valid filter transfers the input data to the upper module. However, according to another exemplary embodiment, in case 440 in which the 0-th and 1st bytes fulfill the first and second conditions, respectively, the first valid filter transfers the input data to the upper module in both the AND and OR operations.

FIG. 5 is a diagram illustrating an example of a data filtering method that uses a second valid data filter, which uses a relative value according to an exemplary embodiment of the present invention.

Referring to FIG. 5, a second valid data filter sets a filtering condition based on a relative value, determines whether the input data fulfills the filtering condition, and filters the input data. Here, the valid data filter may filter the input data by a byte unit or signal unit; however, FIG. 5 illustrates the exemplary embodiment of filtering the input data in a byte unit.

In an exemplary embodiment, the filtering condition may include a condition for comparing present input data and previous input data, and according to the comparison result, transfer the present input data to the upper module. Especially, in a case where the input data consists of a plurality of data units that include a first data unit, a second data unit, and a third data unit, the filtering condition may include a first condition and a second condition. Here, the first condition is for transferring the input data to the upper module according to the result of comparing the first data unit and the first value of the previous input data. The second condition is for transferring the input data to the upper module according to the result of comparing the second data unit and the second value of the previous input data. Here, the data unit is a byte or a signal.

Hereinafter, to help with the understanding of a filtering method using a second valid data filter described above, a detailed exemplary embodiment is described referring to FIG. 5. As shown by a reference numeral 500 in FIG. 5, 0-th and 1st bytes are used in the second valid data filter, and a 2nd byte filter is not used. Through an AND operation, if the 0-th and 1st byte fulfills first and second conditions, respectively, the second valid data filter transfers the input data to the upper module. Through an OR operation, in a case where at least one of the 0-th and 1st operations fulfill the filtering condition, the second valid data filter transfers the input data to the upper module.

In an exemplary embodiment referring to a reference numeral 500 as illustrated in FIG. 5, the filtering condition includes a first condition and a second condition. The first condition is for transferring the input data to the upper module if a 0-th byte of the present input data has a difference, greater than 0x10, with the previous input data. The second condition is for transferring the input data to the upper module if the 1st byte of the present input data has a difference greater than 0x20 from the previous input data. Here, it is assumed that FIG. 5 illustrates case 510 where the previous input data has 0x01, 0x10, and 0x40 in the 0-th byte, 1st byte, and 2nd byte, respectively.

In an exemplary embodiment, in case 520 of AND and OR operations, in which the 0-th and 1st bytes fulfill first and second conditions, respectively, the second valid data filter stops the interrupt operation, and does not transfer the input data to the upper module any further. Meanwhile, in case 530 of the AND operation, in which the 0-th byte fulfills the first condition but the 1st byte does not fulfill the second condition, the second valid data filter stops the interrupt operation, and does not transfer the input data to the upper module any further. However, in the OR operation, the second valid data filter transfers the input data to the upper module. Also, in case 540 of the AND operation, in which the 1st byte fulfills the second condition but the 0-th byte does not fulfill the first condition, the second valid data filter stops the interrupt operation, and does not transfer the input data to the upper module. However, in the OR operation, the second valid data filter transfers the input data to the upper module. However, in case 550 of the AND operation, in which the o-th and 1st bytes fulfill the first and second conditions, respectively, the second valid data filter transfers the input data to the upper module in both the AND and OR operations.

FIG. 6 is a diagram illustrating an example of a data filtering method using a data interval filter, a first valid data filter, and a second valid data filter, according to an exemplary embodiment of the present invention.

Specifically, FIG. 6 illustrates filtering the input data in a signal unit, using all of a data range filter, a first valid data filter using an absolute value, and a second valid data filter using a relative value.

Here, through an AND operation, in a case in which all of 0-th, 1st, and 2nd bytes fulfill filtering conditions, the filters transfer input data to an upper module. Through an OR operation, in a case in which one of the 0-th, 1st, and 2nd signals fulfills the filtering conditions, the filters transfer the input data to the upper module.

According to an exemplary embodiment as shown by a numeral reference 600 in FIG. 6, in a case in which the input data includes the 0-th, 1st, 2nd, and 3rd bytes, the filtering conditions include a first condition to transfer the input data to the upper module using a first valid data filter in a case where the 0-th byte of present input data is greater than 0x10; a second condition to transfer the input data to the upper module using the data range filter in a case where the 1st byte is greater than 0x04 and less than 0x0F; and a third condition to transfer the input data to the upper module using the second valid data filter in a case where the 2nd byte of the present input data has its difference greater than 0x50 compared to the previous input data. In addition, the 3rd byte does not use the filters. It is assumed that FIG. 6 illustrates case 610 where the previous input data has 0x0A, 0x1F, and 0x01 in the 0-th byte, 1st byte, and 2nd byte, respectively.

According to an exemplary embodiment, in case 620 in which the 0-th, 1st, and 2nd bytes does not fulfill the first, second, and third conditions, respectively, the filters stop the interrupt operation and do not transfer the input data to the upper module any further. In comparison, in case 630 in which the 0-th byte fulfills the first condition but the 1st and 2nd bytes do not fulfill the 2nd and 3rd conditions, respectively, the filters stop the interrupt operation, and do not transfer the input data to the upper module in the AND operation. Meanwhile, in the OR operation, the filters transfer the input data to the upper module. Also, in case 640 of the AND operation, in which the 1st byte fulfills the second condition but the 0-th and 2nd bytes do not fulfill the first and third conditions, respectively, the filters stop the interrupt operation, and do not transfer the input data to the upper module any further. Meanwhile, in the OR operation, the filters transfer the input data to the upper module. In comparison, in case 650 in which the 0-th, 1st, and 2nd bytes fulfill the first, second, and third conditions, the filters transfer the input data to the upper module in both the AND and OR operations.

According to an exemplary embodiment, an expansion of an AUTOSAR standard may decrease a CPU occupancy rate used in communications. Moreover, decreasing the CPU occupancy rate used in the communications may increase expandability of a module basically operating in each user application and task. Furthermore, a code relating to any change in sensor data or other communication values acquired from a communication or user may be omitted. Particularly, by optimizing functions, which are used in the communications, in an ECU, such as a car, which processes a lot of data, a multipoint control unit (MCU) that is comparatively less expensive may be selected, and both component unit cost and time consumed in development may be reduced.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Automotive Open System Architecture (AUTOSAR)-based communication method, comprising:
setting a filtering condition based on a data range; and
determining whether input data fulfills the filtering condition, and filtering the input data.

2. The AUTOSAR-based communication method of claim 1, wherein the filtering condition comprises executing an interrupt operation that transfers the input data to an upper module in a case in which the input data exists within a data range that is preset, and in a case in which the input data does not exist within the data rage, not transferring the input data to the upper module and stopping the interrupt operation.

3. The AUTOSAR-based communication method of claim 2, wherein in a case in which the input data comprises a plurality of data units, the filtering condition comprises:
a first condition to transfer the input data to the upper module in a case in which a first data unit exists within a first data range; and
a second condition to transfer the input data to the upper module in a case in which a second data unit exists within a second data range.

4. The AUTOSAR-based communication method of claim 3, wherein the data unit is a byte or a signal, wherein a unit of the signal is a bit or a byte.

5. The AUTOSAR-based communication method of claim 3, wherein the filtering of the input data comprises executing an interrupt operation that transfers the input data to the upper module in a case in which the input data fulfills an OR condition where the input data fulfills one of the first and second conditions, and in a case in which the input data does not fulfill the OR condition, not transmitting the input data to the upper module and stopping the interrupt operation.

6. The AUTOSAR-based communication method of claim 3, wherein the filtering of the input data comprises executing an interrupt operation that transfers the input data to the upper module in a case in which the input data fulfills an AND condition where the input data fulfills both the first condition and the second condition, and in a case in which the input data does not fulfill the AND condition, not transmitting the input data to the upper module and stopping the interrupt operation.

7. An Automotive Open System Architecture (AUTOSAR)-based communication method, comprising:
setting a filtering condition based on an absolute value or a relative value of valid data; and
determining whether input data fulfills the filtering condition, and filtering the input data.

8. The AUTOSAR-based communication method of claim 7, wherein the filtering condition comprises comparing the input data and the absolute value that is set in advance, and transmitting the input data to an upper module according to the comparison result.

9. The AUTOSAR-based communication method of claim 8, wherein in a case in which the input data comprises a plurality of data units, the filtering condition comprises:
a first condition to transfer the input data to the upper module according to a result of comparison between a first data unit and a first absolute value; and
a second condition to transfer the input data to the upper module according to a result of comparison between a second data unit and a second absolute value.

10. The AUTOSAR-based communication method of claim 9, wherein the data unit is a byte or a signal, wherein a unit of the signal is a bit or a byte.

11. The AUTOSAR-based communication method of claim 9, wherein the filtering of the input data comprises executing an interrupt operation that transfers the input data to the upper module in a case in which the input data fulfills an OR condition where the input data fulfills one of the first and second conditions, and in a case in which the input data does not fulfill the OR condition, not transmitting the input data to the upper module and stopping the interrupt operation.

12. The AUTOSAR-based communication method of claim 9, wherein the filtering of the input data comprises executing an interrupt operation that transfers the input data to the upper module in a case in which the input data fulfills an AND condition where the input data fulfills both the first condition and the second condition, and in a case in which the input data does not fulfill the AND condition, not transmitting the input data to the upper module and stopping the interrupt operation.

13. The AUTOSAR-based communication method of claim 7, wherein the filtering condition comprises comparing present input data and previous input data, and transmitting the present input data to the upper module according to the comparison result.

14. The AUTOSAR-based communication method of claim 13, wherein in a case in which the input data comprises a plurality of data units, the filtering condition comprises:
a first condition to transfer the input data to the upper module according to a comparison result between a first data unit and a first value of the previous input data; and
a second condition to transfer the input data to the upper module according to a comparison result between a second data unit and a second value of the previous input data.

15. The AUTOSAR-based communication method of claim 13, wherein the filtering of the input data comprises executing an interrupt operation that transfers the input data to the upper module in a case in which the input data fulfills an OR condition where the input data fulfills one of the first and second conditions, and in a case in which the input data does not fulfill the OR condition, not transmitting the input data to the upper module and stopping the interrupt operation.

16. The AUTOSAR-based communication method of claim 13, wherein the filtering of the input data comprises executing an interrupt operation that transfers the input data to the upper module in a case in which the input data fulfills an AND condition where the input data fulfills both the first condition and the second condition, and in a case in which the input data does not fulfill the AND condition, not transmitting the input data to the upper module and stopping the interrupt operation.

17. An Automotive Open System Architecture (AUTOSAR)-based communication apparatus, comprising at least one of:
a data range filter configured to set a filtering condition based on a data range, determine whether input data exists within the data range that is preset, and filter the input data based on the determination result;
a first valid data filter configured to set a filtering condition based on an absolute value of valid data, compare the input data and the absolute value that is preset, and filter the input data according to the comparison result; and
a second valid data filter configured to set a filtering condition based a relative value of on the valid data, compare present input data and previous input data, and filter the input data according to the comparison result.

18. The AUTOSAR-based communication apparatus of claim 17, wherein the data range filter, the first valid data filter, and the second valid data filter are configured to be located in a Controller Area Network (CAN) interface module.

19. The AUTOSAR-based communication apparatus of claim 17, further comprising:
a controller configured to activate at least one of the data range filter, the first valid data filter, and the second valid data filter in a case in which the input data comprises a plurality of data units, to execute an interrupt operation to transfer the input data to the upper module in a case in which the input data fulfills an OR condition that fulfills any one filtering condition of the at least one activated filter, and to stop the interrupt operation without transferring the input data to the upper module in a case in which the input data does not fulfill the OR condition.

20. The communication apparatus of claim 17, further comprising:
a controller configured to activate at least one of the data range filter, the first valid data filter, and the second valid data filter in a case in which the input data comprises a plurality of data units, to execute an interrupt operation to transfer the input data to the upper module in a case in which the input data fulfills an AND condition that fulfills all the filtering conditions of the at least activated filter, and to stop the interrupt operation without transferring the input data to the upper module in a case in which the input data does not fulfill the AND condition.
